(19) United States
(12) Patent Application Publication
(10) Pub. No.: US 2005/0287293 A1
(43) Pub. Date: Dec. 29, 2005

(54) Coated wallboard process

(76) Inventor: John Rothman, Lebanon, NJ (US)

Correspondence Address: MCHALE & SLAVIN, P.A., 2855 PGA BLVD, PALM BEACH GARDENS, FL, 33410, US

(21) Appl. No.: 10/880,340

(22) Filed: Jun. 29, 2004

(51) Int. Cl. B05D 3/12

(52) U.S. Cl. 427/171; 427/372.2; 427/289

(57) ABSTRACT

Disclosed is a process for the manufacture of construction board utilizing a polymeric coating for protection. Particularly, the invention relates to the use of polyurea containing coating systems containing either pure polyurea or polyurea systems which include polyurethanes, polyols, polyacrylics, polyethers and the like. The polyurea coating system is to provide protection of construction board from environmental conditions, damage during transport, molds and insects. Moreover, the polyurea coating system can contain additional excipients to provide various properties including insulation, reflection and fire resistance. Additionally, the polyurea system coating system exhibits excellent formulation flexibility and can be incorporated into existing industrial manufacturing processes without slowing down the manufacturing process.

### FIELD OF THE INVENTION

This invention is directed toward polymeric coated manufactured construction board and a method for manufacturing thereof utilizing an in-line mass production process, wherein the polymeric coating creates a barrier protection in the form of one or more water resistant, or waterproof, surfaces upon said construction board. The invention particularly relates to the application of a polyurea based coating system to construction board (e.g., gypsum board, fiberboard, or particle board) during the manufacturing process, wherein construction board having enhanced properties inclusive of water, mold, fire and heat transfer resistance is provided.

### BACKGROUND OF THE INVENTION

The use of gypsum (calcium sulfate dihydrate) in industrial and building products is common since it is plentiful and generally inexpensive to manufacture. Gypsum wallboard, also known as plasterboard or drywall, generally comprises a rehydrated gypsum core sandwiched between paper sheets. Current production methods for the manufacture of construction board typically involve, in the case of gypsum board for example, a relatively long production line in which a paper backing having raised sidewalls is fed in a continuous strip onto a moving bed production line into which the gypsum slurry is poured and onto which a covering paper top is then laid. This long ribbon of paper covered gypsum slurry passes through a series of rollers, and then continues down the production line for a considerable distance while the surface of the gypsum is allowed to air dry, following which it is cut into individual sheets and passed through a kiln, or oven, for final drying. Finally, tape is applied to the open ends of the sheet and the board is stacked on pallets.

Additionally, similar composite material can be used to make a paper-less gypsum wallboard known in the art as “fiberboard.” The term fiberboard is used to distinguish fiber-reinforced gypsum panels from drywall or wallboard, which has at least one surface is comprised of paper. Fiberboard has different surface characteristics than conventional paper-covered wallboard. Conventional fiberboard has been known to create problems for tradepersons who use and/or install such panels. In the absence of the paper surface, prior art fiberboards tend to absorb water quickly. As a consequence, when joint compound, or plaster, is applied to such panels the joint compound dries prematurely, impairing its ability to be properly finished. Similar problems can present themselves when adhesive and/or paint are applied to fiberboard.

Conventionally manufactured construction board such as gypsum wallboard, particle board, or any material containing organic ingredients, are especially vulnerable to moisture and subsequent attack by molds such as Stachybotrys, Penicillium, Aspergillis and other species. Various species of molds are able to utilize the cellulose materials in the paper coating and the starch used as a binder for the gypsum as nutrients. Similarly, the organic wood composition of particleboard is nutritive for black mold. These mold species can be both pathogenic and toxic, thus it is imperative that their growth be eliminated or at least retarded.

Another problem associated with gypsum wallboard and fiberboard is their intrinsic weakness and friability, which is exacerbated by moisture. This problem also exists for particleboard, albeit to a lesser extent. There has been a longfelt need in the construction industry for forms of dry wall, sheet rock, particleboard and fiberboard that are resistant to damage by the elements during the construction process. Until now, the typical method employed to protect construction board was to cover the boards during transit, or at the job site, with a plastic material, or alternatively to enclose part of the construction site to protect these materials from the elements.

Since construction is generally conducted without concern for predictability of the weather, large portions of these materials are ultimately lost due to damage from the environment. The building industry has sought to solve this problem by the application of an aluminum-based sheet type material after these materials have been installed. Unfortunately, this nevertheless leaves the surface of these composite materials exposed to the elements for periods of time prior to the installation of the protective materials. Moreover, these methods are time consuming and labor intensive. Alternatively, specialty construction boards with coatings of fiberglass or other materials appreciably elevate the manufacturing cost of the board. Such methods do not readily lend themselves to the rapid, mass production line methods commonly utilized for their manufacture, and only result in higher costs due to the use of more expensive materials and slower production methods.

Additionally, the building industry has tried to solve the above-mentioned problems by coating construction boards with polymer systems based on polyurethane, epoxy, and acrylics. These polymer systems are usually added as a final step in the manufacturing process and usually require at least a 12 hour cure period, and in some cases 24 hours, before the coated area can be moved or put into service. These lengthy cure rate periods diminish, or eliminate, the possibility of application of the coatings in a timely and efficient manner during the manufacturing process. Moreover, these polymers often require substantial amounts of volatile organic solvents which are environmentally harmful and regulated by the Environmental Protection Agency (EPA) such that a manufacturing facility that is close to their allowed limit of volatile organic compounds (VOC) emissions may be precluded from using epoxies, or other conventional polymers, as their use would exceed the acceptable VOCs allowed at the manufacturing facility. Thus, if a process could be provided for creating a construction board product that was both protected from the elements and able to be produced without substantial modification to existing processes, this would be a substantial step forward in the art.

### DESCRIPTION OF THE PRIOR ART

U.S. Pat. No. 6,442,912 and WO 99/28125 both to Philips et al, which are incorporated by reference herein in their entirety, disclose applying a coat of an elastomeric system, specifically polyurea or polyurethane, to a base substrate. The elastomeric system may have fire retardants added therein. Additionally, Philips et al teach that the building substrate may be any conventional building material, e.g. gypsum type boards. Philips et al teach that the elastomeric coating is applied before the substrate is attached to the siding, so that during the shipment of the individual substrates, breakage is kept to a minimum. Phillips et al further teach that polyurea is the preferred elastomeric coating because the polymer does not require a catalyst and the reaction is both relatively temperature and water inert. Philips et al fail to teach or disclose a continuous manufacturing line method for applying the elastomeric coating to the substrate. Moreover, Phillips et al teach preformed foam panels covered with an elastomeric and, further indicates that the elastomeric coating may be used as an adhesive.

U.S. Pat. No. 5,965,207 to Kropfeld et al disclose a method of applying a polyurethane coating on engineered particleboards in a continuous manufacturing line, wherein the coating is cured subsequent to application. The patent also states that engineered particleboards may be coated directly with a polyurea coating. However, Kropfeld et al have determined that the polyurea coating must be relatively thick (greater than about 0.04 inches) and the polyurea coating polymers are relatively expensive. Kropfeld et al teach that the method of this invention provides a thin waterproof coating on the engineering boards that is relatively inexpensive, particularly when compared to other polymer coatings such as polyurea. Kropfeld et al differ significantly from the instant invention in that it specifies levels of coating that are an order of magnitude greater than specified herein, it makes use of polyurea only as a coating for a cement layer which must be first applied to surfaces to be coated. Additionally, Kropfeld et al fail to teach or suggest an ability to apply such a coating in the context of a commercial production process, which is the provenance of the instant invention.

U.S. Pat. No. 4,902,348 to Kossatz et al, which is incorporated by reference herein in its entirety, teaches a process for the manufacture of reinforced gypsum plasterboard by the addition of polyisocyanate in the production process. Various processes may produce the plasterboard, either continuously or batchwise. Kossatz et al also teach wetting water-moistened wood chips with polyisocyanate before being pressed to form the plasterboard in order to provide water-resistance throughout the cross-section of the plasterboard. Alternatively, the plasterboard can be made water-resistant on the external surfaces. Kossatz et al teach plasterboard that is strengthened with reinforcing materials, preferably cellulose particles, in addition to the polyisocyanate. Kossatz et al do not disclose or suggest a polyurea containing coating applied in the context of a contiguous commercial production process. Nor does Kossatz et al teach the use of a polyurea coating other than as an adjunct to the inclusion of wood chips or cellulose materials to impart strength.

### SUMMARY OF THE PRESENT INVENTION

The present invention is directed toward a novel process that enables conventional methods used to fabricate manufactured construction board such as gypsum wall board, particleboard, fiberboard and so forth, to be adapted such that the constructed board is either coated in part, or completely enclosed, within a water proof or water resistant coating polyurea containing coating. In its most basic adaptation, this membrane provides a strong elastomeric barrier effective for preventing external damage and/or mold growth from reaching the internal gypsum composition. In alternative embodiments, the polymer can be adapted to provide energy saving, insulating and other useful properties through the addition of excipients, such as borosilicate microspheres, reflective pigments, fungicides, and the like. The construction board of the instant invention is acceptable for wall, floor and ceiling applications.

Polymer coating systems used in the instant invention are based on polyurea or polyurea containing formulations (e.g. polyurea combined with polyurethanes, or polyethers, or polyacrylics) that can be cured in only about 5-20 seconds at ambient temperatures, e.g. approximately 23° C. or 73° F., subsequent to application. This short cure rate period creates a timely and efficient manufacturing process. Moreover, the present invention does not require the use of any VOCs when a pure polyurea coating is used in the manufacturing process and only a relatively minor amount of VOCs are needed for other polyurea containing coatings, when compared with epoxy, pure polyurethane, or other coatings.

The method of applying the polyurea coating system of the present invention utilizes essentially the same equipment as the standard production line methods currently used to produce manufactured construction board, and the process takes the same amount of time as is currently required by in-line methods. Thus, the product that results is a superior product that does not require considerable engineering and equipment cost, and can be made at the same production rate as conventional construction board. Additionally, the polyurea containing coating system of the instant invention can be used as a final step in the manufacture of construction boards at a separate facility. The aqueous dispersion of the polymer solution may be applied to one or more surfaces of the construction board by various methods, illustrated by, albeit not limited to brush coating, roller coating, spraying or immersion and then drying.

Additionally, the polyurea containing coating system of the instant invention can be used on paperless fiberboard and particleboard. The application of the coating system onto fiberboard provides an improvement in paint and joint compound performance. The application of the current coating system provides water resistance, which protects the paint and/or joint compound from drying out prematurely. This gives the tradespersons installing the fiberboard more working time in the application of paint and/or joint compounds. Moreover, like the paper-coated wallboard, the polyurea coating system provides improved resistance to damage both before and after decoration.

It is an therefore an objective of the present invention to provide a coated construction board which is protected from moisture and exposure to the environment during the construction process.

Another objective of the instant invention is to provide a protective coating to conventional construction board such that it has increased strength, including flexural strength, dent resistance, and durability.

A further objective of the instant invention is to provide a coating to conventional construction board that is partially or completely resistant to mold growth.

Another objective of the present invention is to provide a coating process which can be easily and economically incorporated into the conventional construction board manufacturing process without requiring re-engineering of the process or reducing production times or volumes.

Yet a further objective of the of the instant invention is to provide a coating system suitable for use on particle board, fiberboard and paper-reinforced gypsum panels.

An additional objective of the invention is to provide a polyurea containing system which has a cure rate of approximately 5 to 20 seconds on the surface of the treated material.

Yet an additional objective of the instant invention is to teach a method to produce a construction board that is not only resistant to damage, but also easy to maintain, difficult to deface, capable of manufacture in many colors, hues, textures, and suitable for use as a finished wall.

Another objective of the instant invention is to teach a process that can coat different surfaces, such that it can be applied to augment the paper coating of gypsum board, entirely replace the paper coating, or be applied to previously uncoated products.

Still another objective of the polymer coating system is to provide therein additional excipients; such as fungicides, insecticides, insulating and fire retardant components.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a schematic diagram illustrating various process equipment often used in standard continuous process of making construction board, incorporating a first method of applying the polyurea containing coating system of the present invention.

FIG. 2 is a schematic diagram illustrating a standard continuous process of making construction board, incorporating a second method of applying the polyurea containing coating system of the present invention.

FIG. 3 is another schematic diagram illustrating a standard continuous process of making construction board, incorporating a third method of applying the polyurea containing coating system of the present invention.

FIG. 4 is partial schematic diagram illustrating a portion of a standard continuous process of making construction board as shown in FIG. 3, this portion of the conveyor creates a mold into which the polyurea containing coating system of the present invention is applied.

### DETAILED DESCRIPTION OF THE INVENTION

The instant invention provides a manufacturing process wherein rapidly setting polymeric material based upon polyurea systems are applied to construction board in several alternative embodiments which enable either the total or partial coating of manufactured construction board with a water resistant, or waterproof, coating. This coating can be used as an external surface on top of the normally provided paper coating of gypsum wallboard, or as a replacement for such pre-existing coatings, or to coat previously uncoated materials, such as fiberboard. The polymer system of the present invention comprises a family of compounds including aromatic and aliphatic polyurea materials, polyurethane materials, polyethers, polyacrylics, and various other resins and similar coating materials, characterized by their ability to set and cure quickly. Further, these materials are not greatly influenced by ambient moisture, temperature and humidity, thus enabling them to set and cure quickly in otherwise inhospitable environments.

The present invention contemplates a variety of alternative embodiments, which may be dependent upon the material to be coated, the nature of the coating desired, the production process used to manufacture the finished product which is to be adapted, and so forth. Additionally, many different properties can be imparted to the finished coated board depending upon the specific method of application and composition of the polyurea containing coating system used.

The instant invention is based upon a class of coating agents that are generically described as polyurea containing agents. A pure polyurea coating may be the preferred embodiment in many cases since it requires no catalyst. Pure polyurea is formed essentially spontaneously, typically in a period of from about 5 to about 20 seconds at ambient temperature, through the reaction of two solutions, the first being an isocyanate and the second being a polyamine. Since the reaction rate is normally faster than the rate at which the isocyanate solution can react with moisture or water, this enables the application of pure polyurea coatings in high humidity conditions or onto moist substrates.

Additionally, the polyurea coating system can be a multicomponent system, for example a polyurea/polyurethane system. In this example, a polyurea coating system is formed through the reaction of two solutions in the presence of the catalyst, appropriate catalysts being known in the art. The first solution is isocyanate and the second solution is a polyol, illustrated by but not limited to, a polyester, polyacrylic or polyether. Nomenclature regarding what is a polyurea and what is polyurethane is based upon convention, which has changed in the past and may change in the future. For the purpose of the instant invention, polyurea containing coating systems are defined as any system that contains any quantity of polyurea.

The polyurea family, whether aliphatic, aromatic, or any combinations derived therefrom, will be appreciated by those skilled in the art from the following detailed description. Aromatic and aliphatic polyurea spray elastomeric systems are easily achieved by changes in formulation compositions and they are comprised of 100% solids. The elastomeric system(s) comprised of, but not limited to, aromatic and aliphatic polyurea spray elastomeric system(s) or any combination systems derived therefrom, or any spray systems with a polyurea component in accordance with the present invention have preferred characteristics over other coatings such as epoxy, polyurethane in the absence of polyurea, and polyesters, as well as polyethylene and polypropylene materials. The thickness of the film will depend on the physical qualities desired and the specific formulation used. The polyurea coating system of the present invention generally utilizes a minimum film thickness of about 1 mil in a single coat, preferably the film thickness is approximately between about 1 mil and about 40 mil with a preferred thickness between about 4 and about 20 mil. While it has been classically important that the minimum film thickness of coating be applied to the substrate such that the polyurea system will develop sufficient exothermic heat to cure properly, regardless of ambient temperature, such minimum thickness is not a requirement of the instant process since, depending upon the embodiment, heat from the in-line drying oven can be utilized to increase the reaction rate of relatively thin films. However, if desired, external heat sources can be incorporated along the production line, from radiant heating sources, and so forth as needed.

The present invention can be applied to any form of manufactured board with the ability to make adjustments to the composition of the polyurea system in order to produce a coating with the desired characteristics. For example, in the specific instance where it is desired to impart water resistance in an economical manner to standard paper covered gypsum wallboard, a polyurea coating system comprising a combined polyurethane/polyurea system is desired since it is less viscous than a pure polyurea and the coating material is able to penetrate through the covering such that upon curing the polymer cross-links within and through the paper matrix. In this manner water resistance can be applied with a thin coat that is functional and, because it requires little coating material, economical. Alternatively, in the event that a more viscous or durable coating is desired, for example as a replacement for the paper coating on fiberboard, a polyurea coating system comprising pure polyurea might be preferred.

As previously discussed above, depending upon the specific formulation used, heat can be an important component of the manufacturing process. By increasing the heat applied to the polyurea coating systems in their storage tanks and/or hoses as the coating system is delivered to the substrate, or by heating the substrate itself, the reaction rate (Q₁₀) can be increased to accelerate the rate of curing. This can also be achieved by various means such as heating the local area in which the coating is sprayed, by heating the production belt onto which the coating is applied, coating the warm construction board as it comes out of the oven, or by other means known in the art as will become apparent from the detailed discussion below.

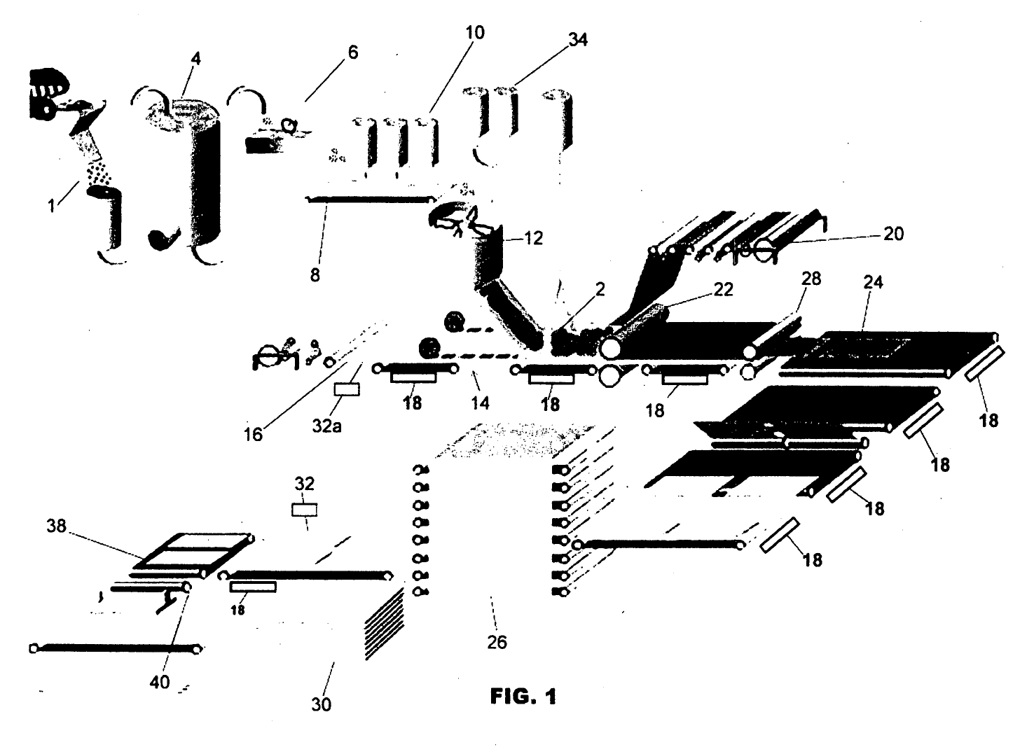

Referring now to FIGS. 1-4, wherein like elements are numbered consistently throughout, FIG. 1 illustrates a standard continuous manufacturing in-line process used to manufacture construction board. Construction board, for example gypsum board, is generally manufactured in a plant wherein the mined gypsum (1) is first crushed and calcined and added to a mixer (4) to make it suitable for making a slurry. The gypsum is then weighed on a scale (6) and is discharged directly onto a top conveyor belt (8) wherein additional additives, contained in dispensers (10), such as fiberglass, or other slurry enhancing agents known in the art, can be added. The gypsum mixture and water added from a conventional boiler (34) are then added to a mixer (12) the resulting slurry (2) is extruded directly onto a ribbon of paper (16) with raised edges that is released onto another conveyor in the production line, (14). One or more additional heating means (18) may be provided at one or more of the areas along the production line indicated in FIGS. 1-3 in order to increase rate of curing of the polyurea coating system. The gypsum slurry (2) can then undergo additional core enhancing treatments. For example, additional additives (not shown), such as air entrapment additives, may be added to the center portion of the slurry (2) and used to make the gypsum core lighter without significant degradation to its strength.

Additionally, this gypsum slurry (2) can be surface treated by a surface treatment means (20). The surface treatment can include various coverings, e.g. paper covering, decorative coverings, and/or lamination. This surface treated gypsum slurry passes through a series of rollers (22) the rollers can contain additional heating means (not shown) as known in the art.

The continuous strip of construction board then moves down the conveyor for a considerable distance. The surface of the gypsum is allowed to air dry, following which it is cut by a slicing means (28) into individual sheets (24), moved along additional conveying means and passed through a kiln, or oven, (26) for final drying. After leaving the oven (26), a thin, controlled volume of polyurea coating system is applied to the top surface of the surface treated construction board in a precise fashion that minimizes or eliminates over applying the coating to elements of the production line other than the board via an application means (32) as it is conveyed to dry transfer station (38), wherein the polyurea coating system cures in about 5 to 20 seconds after application before reaching the dry transfer station (38). Finally, tape (not shown) is applied to the sliced ends of the sheet via finishing means (40) and the finished construction board is stacked on pallets (30). A similar process is used for particleboard, cement board and other manufactured construction board products.

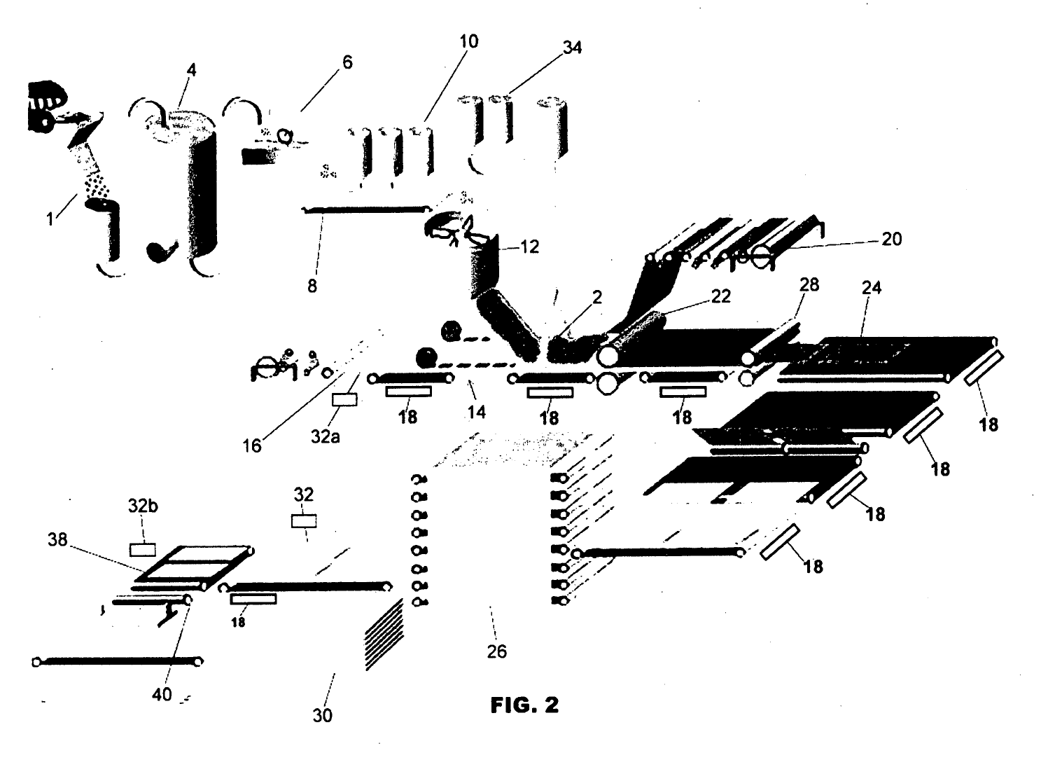

Now referring to FIG. 2, an alternative embodiment of the method of the present invention as seen in FIG. 1 is illustrated. The method of FIG. 2 illustrates complete encapsulation of manufactured construction board, for example gypsum board, in order to provide a completely inorganic coating that is waterproof and resistant to mold growth. This can be obtained by applying the polyurea coating system (32a) directly to either side of the continuous strip of paper, or web, (16) as it is fed onto conveyor (14). In this example the application means (32a) is shown on only one side, the lower side of the strip (16). Onto the strip (16) is poured the gypsum slurry (2) that then proceeds along the conveyor (14). Again, this gypsum slurry (2) can be surface treated by a surface treatment means (20). This board (24) is then sliced to length via slicing means (28), passed through the oven (26), and otherwise processed in same manner as FIG. 1. Upon exiting the oven the dried board (24) has applied thereto a coat of a polyurea containing system via application means (32) and the ends of the boards are then coated by application means (32b) and stacked on pallets (30), thus totally encapsulating the gypsum core with the inorganic polyurea coating that penetrates and sheaths the paper.

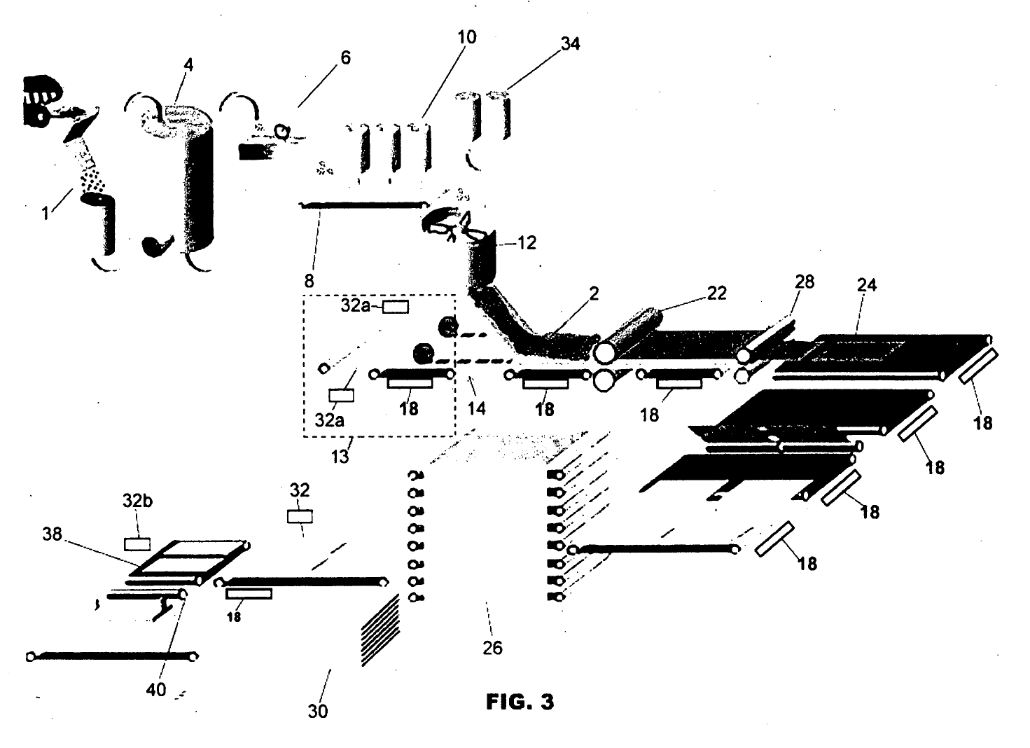

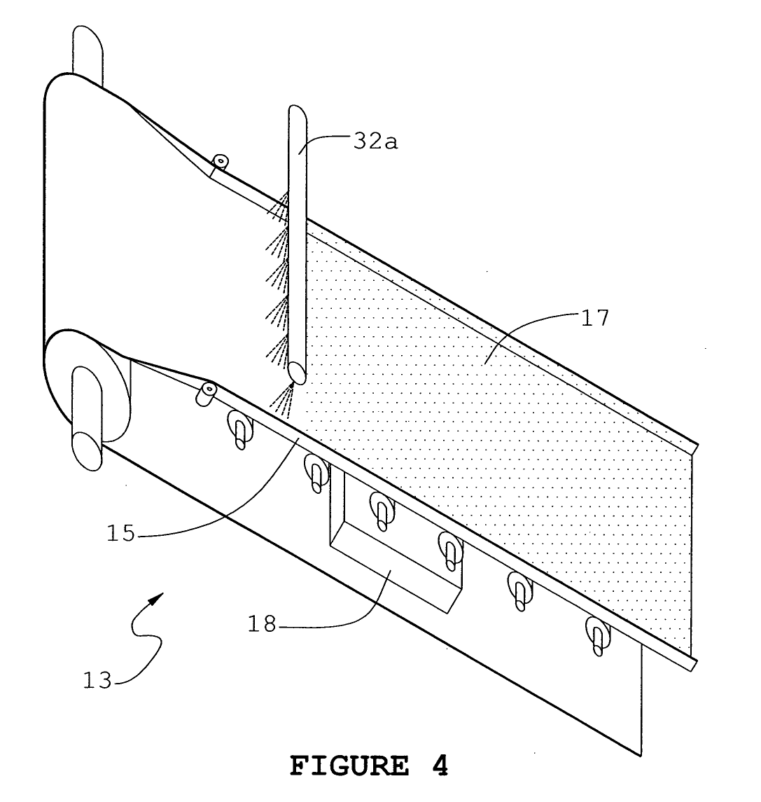

Now referring to FIG. 3, an alternative embodiment of the method of the present invention is illustrated wherein is created an elastomeric polymer clad gypsum board without a paper covering, or alternatively a polymer covered fiberboard, particle board, and so forth. This method is practiced by applying the polyurea system via application means (32a) directly to the non-stick floor of a conveyor segment (13) shown in more detail in FIG. 4, that replaces that portion of the production line previously used to feed the bottom layer of paper (16) into the process line (14). In the proposed, albeit non-limiting embodiment, an initial non-stick conveyor belt segment (13) has wedges, or rails, (15) in place along the lateral portions of the conveyor which function to push the edges of the conveyor inward such that it creates a mold into which the polyurea coating system is applied by application means (32a). This segment (13) may also be heated by heating means (18) such that within about 5 to 20 seconds after application of the polyurea coating system there results a membrane shell (17) that comprises the back and sides of the construction board. Following the rapid set and cure of this polymer shell (17), it transits from the non-stick conveyor segment (13) to the process line (14) as seen in FIG. 3. Into this membrane shell (17) is poured, by way of example, the gypsum slurry (2) which subsequently proceeds along the process line (14) absent a top cover. This paperless board (24) is then cut to length by slicing means (28), passed through the oven (26), and otherwise processed in same manner as FIG. 1. After the construction board leaves the oven (26), a controlled volume of polyurea coating system is applied to the top surface of the gypsum slurry via an application means (32) in the same manner as presented in FIG. 1, wherein the polyurea coating system cures in about 5 to 20 seconds after application. In this instance the top coating of a polyurea system is formulated to provide structural protection and water resistance in the absence of an underlying paper coating. The application of the polyurea coating system of the present invention onto fiberboard provides many improvements in product performance, including paint and joint compound finishing, waterproofing, mold proofing, dent and damage resistance, longer life on job sites, low maintenance, and so forth.

As set forth above, the method of this invention may also be utilized to provide a polyurea coating on a single side, all sides and/or one or all of the sliced ends of the various types of construction board, with or without paper covering. While the manufacturing processes of the above mentioned construction boards may vary, the application of the polyurea containing membrane of the present invention nevertheless cures quickly, thereby allowing the finished wallboard to complete its normal process of manufacturing such that the wallboard continues down the conveyor system approximately 10-20 seconds after leaving the application means (32, 32a, 32b) without adverse affects to the manufacturing process. The present invention offers a new and efficient method of applying a protective membrane with unique and highly desirable attributes without slowing down the manufacturing process, which has heretofore not been achieved, and without requiring substantial re-engineering of the production process.

Although the primary objective of this invention is to demonstrate a new and efficient process to apply a polyurea containing coating system to manufactured construction board to protect against the environment, it has been discovered that the present polyurea coating system also eliminates mold growth, provides a surface inert to chemicals, and increases resistance to dents and damage. Other benefits incorporating this process are numerous and can be utilized at the same time without slowing down the manufacturing process.

### EXAMPLES

The following examples are provided to illustrate additional excipients that can be added in addition to the polyurea coating system of the present invention without detriment to the process, but are not intended to limit the scope of the invention.

### Example 1

For example, when applying the polyurea elastomeric system(s) to the construction board one can incorporate different pigments and granules, see co-pending U.S. application Ser. No. ______, filed on Jun. 29, 2004 by Express Mail No. EV472807340US herein incorporated by reference in its entirety, which describes a coating composition containing a plurality of evacuated borosilicate glass microspheres of a size distribution and density effective to maximize properties of diffusive reflectivity and emissivity. These microspheres can range in size from the nanometer to micrometer when added to the polyurea coating composition and achieve insulating solar reflectance, and thermal emissivity properties. Additionally, the use of highly reflective pigments, such as those containing Titanium Dioxide (TO₂), result in increased reflectivity. Similarly, the addition of microscopic granules creates a micro-granularity on the surface resulting in diffuse reflection that is attended by dramatic increases in emittance.

In the preferred embodiment, partially or fully evacuated borosilicate microspheres are the micro-spherical additive, as they add not only micro-granularity but can be evacuated to provide the property of insulation as well. Because they are partially evacuated they function as an insulator. A surprising effect occurs with the addition of the borosilicate microspheres evenly to both the “A” and “B” sides of the polyurea system in a range of about 0.2 to 8 oz. per gallon, in particle sizes between about 2 to 25 microns, namely the ability to prevent radiated electromagnetic energy being transduced into heat energy which normally occurs as a result of molecular excitation by the radiant energy. Thus, this unique coating prevents the construction board from getting hot in the sun by reducing the sun's energy available to be transduced into heat by as much as 99% or more.

Hemispherical emittance was calculated from normal emittance by using equations 4 and 5 provided by the National Rating Council in NFRC 301-93. Hemispherical spectral reflectance measurements were performed in accordance with ASTM standard Test Method E 903-88 (1992). The measurements were performed with a Beckman 5240 Spectrophotometer utilizing an integrating sphere (FIG. A 1.3 of E 903-88 (1992)). Total reflectance measurements were obtained in the solar spectrum from 2500 nm to 300 nm at an incident angle of 15°. The measurements employ a detector-baffled wall-mounted integrating Sphere that precludes the necessity of employing a reference standard except to define the instruments 100% line. The measurements are properly denoted as being ‘hemispherical spectral reflectance’.

The spectral data were integrated against Air Mass 1.5 global (ASTM E892-87 (1992), Table 1 spectrum utilizing 109 weighted ordinates. The UV region of the spectral data (290 to 400 nm) was integrated using 15 weighted ordinates from Air Mass 1.5 global spectrum. The visible region of the spectral data (410 to 722 nm) was integrated using 25 weighted ordinates from Air Mass 1.5 global spectrum. The NIR region of the spectral data (724 to 2500 nm) was integrated using 69 weighted ordinates from the Air Mass 1.5 global spectrum. All measurements were performed on the coated surface. The values reported for emittance represent the average of at least Four Measurements.

TABLE I
EMITTANCE

| | Reflectance | Near Normal | Hemispherical |
|---|---|---|---|
| Specimen Code | Measured | Emittance | Emittance |
| 779 7 5 1 | 0.05 | 95 | 0.90 |

TABLE II
REFLECTIVITY

| | |
|---|---|
| REFLECTANCE | % REFLECTANCE |

| Specimen Code | UV | VIS | NIR | SOLAR |
|---|---|---|---|---|
| 7779-7-5-1 | 19.09 | 91.4 | 76.9 | 80.7% |
| 7779-7-5-2 | 19.5 | 91.3 | 76.9 | 80.6% |

In TABLE I, the Near-Normal emittance specimens were calculated from Kirchhoff's Relationship. The present invention further demonstrates the value of the inclusion of microspheres, preferably evacuated borosilicate microspheres. Moreover, because the energy efficient properties of borosilicate microspheres in imparting the properties of emittance and insulation to the polyurea coating system, independent of pigment, manufactured construction boards can be made in many colors other than highly reflective white and still manifest great energy efficiency in the prevention of heat formation. This example demonstrates that in addition to a polymeric coating that is waterproof, dent and damage resistant, and easily integrated into the most time sensitive manufacturing process, a construction board can be made that is uniquely and extremely energy efficient.

### Example 2

In addition to Example 1, it has been determined that one could add a fire retardant to the preferred membrane, in combination with the borosilicate microspheres or without. This will add additional fire resistance to the construction board without causing a detrimental effect to the process. Such fire retardants are commercially available and one such retardant is manufactured by the J.M. Huber Corporation under the label of ATH, others include various inorganic salts (e.g. phosphate salts) or urea which undergoes endothermic reactions in the presence of fire. Additionally, the excipient could be a polyhydrate that releases water in the presence of fire.

### Example 3

Black mold, typically consisting of species; Stachybotrys, Penicillium, Aspergillis and similar fungal species are a significant health problem to humans when the spores of these fungi are inhaled. Typical manufactured construction board, whether wallboard, particleboard, or similar materials can support the growth of black mold due to their organic composition. In the case of wallboard, which is among the most common construction materials, both the covering paper and the starch binder used in the slurry core support mold growth. In the presence of moisture often found in high humid enclosed spaces, or in proximity to leaking pipes black, mold spores are virtually ubiquitous. The mold spores germinate and thrive on the organic substrates of most manufactured construction board. By encapsulating such construction board in the present polyurea coating system, which is completely inorganic and highly resistant to moisture, the growth of mold is prevented even in damp conditions, as the surface is inhospitable to the microorganisms. Additionally, commercially available fungicides, mildicides or any other antimicrobial agent(s) can be added to the polymer coating system without being detrimental to the process, thereby providing a biochemical as well as a physical barrier to mold growth, for example Timsen™ sold by UPI.

### Example 4

By adjusting the spray pattern in the application of polyurea coating system of the instant invention during manufacture, one can produce a fully pre-finished “decor” board. With the addition of excipients to provide texture to the polyurea coating system, the present invention offers a new and economical decorator board with features not currently available in the marketplace or currently manufactured. This “decor” board offers a low maintenance pre-finished decorator board that is strong and durable, chemical resistant, mold and mildew resistant, abrasion resistant, and graffiti resistant. Additionally, the board can be produced with different pigments, colors, tints, hues, waterproofing agents, and different designer finishes and insulating value.

### Example 5

One can also create an insect proof board by including within the polyurea coating system an appropriate insect repellant or insecticide agent. Encapsulation of such excipients within the coating system preserves the activity of the insect repellant or insecticide virtually indefinitely. The insecticide agent becomes active when an insect penetrates the polyurea coating sufficient to encounter the agent.

One of ordinary skill will realize that the polymer coating system of the instant invention could incorporate one or all of the above-mentioned excipients. One skilled in the art will readily appreciate that the present invention is well adapted to carry out the objects and obtain the ends and advantages mentioned, as well as those inherent therein. Any compounds, methods, procedures and techniques described herein are presently representative of the many preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. In a method for producing construction board, the improvement comprising:
application of a polyurea containing coating to at least one side of said construction board.

2. The method of claim 1 wherein said polyurea containing coating is applied directly to said construction board.

3. The method of claim 2 further comprising a step of including an excipient within said polyurea containing coating.

4. The method of claim 1 wherein said polyurea containing coating is applied to all surfaces of said construction board.

5. A method for forming a polyurea containing coating system on at least one surface of a manufactured construction board containing rehydrated gypsum, as part of an in-line mass construction board production process comprising:
applying said polyurea containing coating system onto at least one surface of a continuous length of construction board at any point in said in-line mass production process;
exposing said polyurea containing coating system to ambient conditions effective to insure complete curing of said coating system in a time period sufficiently small so as to not impede said in-line mass production process; and
cutting said continuous length of construction board to a desired length;
whereby a construction board containing a polyurea containing coating is produced

6. The method of claim 5 wherein said polyurea containing coating system comprises polyurea.

7. The method of claim 5 wherein said polyurea containing coating system comprises a mixture of polyurea and at least one additional polymeric additive selected from the group consisting of polyurethanes, polyacrylics and polyethers.

8. The method in accordance with claim 5 wherein said polyurea containing coating is applied by spraying.

9. The method in accordance with claim 5, wherein said step of applying a polyurea coating system is effective to permeate any uppermost paper layer and cross link, upon curing, throughout said paper layer, whereby a water and mold resistant surface is created.

10. The method in accordance with claim 5 wherein the polyurea containing coating system is applied to construction board upon emergence from a drying means, whereby rate of curing of said coating is accelerated.

11. The method in accordance with claim 5, further including coating any cut ends of said construction board with said polyurea containing coating.

12. The method as defined in claim 1, wherein said applying step is at least one method selected from the group consisting of brush coating, roller coating, spraying and immersion.

13. The method as disclosed in claim 1, wherein said polyurea containing coating system has a cure rate of about 5 to about 20 seconds.

14. The method as disclosed in claim 1, wherein said step of applying a polyurea containing coating onto said surface is effective to completely cover and encapsulate said manufactured construction board.

15. A method as disclosed in claim 14 wherein said step of applying a polyurea containing coating system includes formation of a polyurea containing form including a face side and upstanding sidewalls perpendicular to said face side and at opposite ends thereof.

16. The method of claim 15 further including the step of filling said polyurea containing form with a core slurry.

17. The method of claim 16 wherein said polyurea containing coating sets and cures within about 10 to 15 seconds subsequent to its application.

18. The method of claim 17 wherein all remaining surfaces are coated with a polyurea containing coating.

19. The method of claim 18 wherein said polyurea containing coating is sprayed.

20. The method of claim 1 wherein said polyurea containing coating system further includes at least one excipient effective to provide a functionality to said construction board selected from the group consisting of water resistance, waterproofing, fireproofing, insect repellency, energy efficiency, reduction in friability, increased rigidity, reduction of mold growth, reduction of bacterial growth, insect repellancy and aesthetic appeal.

21. The method of claim 20 wherein the excipient is a reflective compound.

22. The method of claim 20 wherein the excipient is a Titanium Dioxide.

23. The method of claim 20 wherein the excipient is an emissive compound

24. The method of claim 20 wherein the excipient is glass microspheres.

25. The method of claim 20 wherein the excipient is borosilicate glass microspheres.

26. The method of claim 20 wherein the excipient is an insulating compound.

27. The method of claim 20 wherein the excipient is fully or partially evacuated microspheres.

28. The method of claim 20 wherein the excipient is fully or partially evacuated borosilicate glass microspheres.

29. The method of claim 20 wherein the excipient is at least one mildicide.

30. The method of claim 20 wherein the excipient is at least one antifungal agent.

31. The method of claim 20 wherein the excipient is at least one antibiotic agent.

32. The method of claim 20 wherein the excipient is at least one insecticide.

33. The method of claim 20 wherein the excipient is at least one insect repellant.

34. The method of claim 20 wherein the excipient has fire proofing properties.

35. The method of claim 20 wherein the excipient is an agent selected from the group consisting of urea containing compounds, phosphate salts and silanes which are characterized by an ability to neutralize heat energy by undergoing an endothermic reaction in the presence of fire.

36. The method of claim 20 wherein the excipient is a polyhydrate that releases water in the presence of fire.

37. The method of claim 20 wherein the excipient imparts a desirable aesthetic texture.

38. The method as defined in claim 1, wherein said applying step comprises utilization of a spray means in a manner effective to create a decor manufacturing board.

39. The method of claim 20 wherein the excipient is a color, tint or hue.
